(19) United States
(12) Patent Application Publication
(10) Pub. No.: US 2020/0267944 A1
(43) Pub. Date: Aug. 27, 2020

(54) APPARATUS FOR BEE HIVE LEVELER

(71) Applicant: Ronnie Brannon, East Point, GA (US)

(72) Inventor: Ronnie Brannon, East Point, GA (US)

(21) Appl. No.: 16/287,939

(22) Filed: Feb. 27, 2019

(51) Int. Cl. A01K 47/06; F16M 7/00

(52) U.S. Cl. CPC A01K 47/06; F16M 7/00

(57) ABSTRACT

A bee hive leveler is presented. The bee hive leveler has a bee hive box. The bee hive box has an exterior, an interior, a top, and a bottom. In the interior of the bee hive box is a honeycomb. The bee hive box includes frames for organizing honeycomb. The honeycomb is included for storing pollen and converting to honey. The bee hive has one or more legs for leveling the bee hive.

### FIELD OF THE INVENTION

The present invention relates generally to bee hives, and more particularly to a bee hive leveler.

### BACKGROUND

Many beehives in commercial use comprise a plurality of generally square or rectangular-shaped, hollow, box-like compartments or “floors”, which are manufactured for modular stacking in a tower arrangement.

Typically, the bottom most compartment is the “nest floor” where the queen bee resides and in which procreation occurs. This compartment is closed only at the bottom, and is open at the top.

One or more upper compartments, known as “honey floors”, and having neither a floor nor a ceiling, are arranged above the nest floor so as to be contiguous therewith. Depending on the size of the nest, the amount of honey being produced, and the time of year, the number of honey floors may be either increased or reduced.

From time to time, it may be necessary to access the nest floor for periodic treatments, or to replace it completely. In accordance with the prior art, in order to gain access to the nest floor all of the honey floors must be removed. This, of course, causes great disturbance to the beehive activity.

It is also noted that, while commercial beehives are generally of similar construction, their width, height and length dimensions may differ from region to region.

Further, bee hives require that they are level to allow the honey to be comb plumb. The ground does not necessarily allow for a bee hive with static feet or with no feet to be level. Therefore, it is important and necessary to have a bee hive with adjustable feet to easily allow the bee hive to be level. Further, as bee hives are stacked upon each other, the bee hives tend to lean or become uneven. There is a need to have not only a single level to have a leveler on a bee hive but for each level to have a leveler access to insure being level.

### BRIEF DESCRIPTION OF THE DRAWINGS

FIG. 1 shows the components of a bee hive.

FIG. 2A is an exemplary leveling system.

FIG. 2B is a further exemplary leveling system.

FIG. 3 is a view of the exemplary leveling system with a bee hive.

### DETAILED DESCRIPTION

Reference will now be made in detail to the present preferred embodiments, examples of which are illustrated in the accompanying drawings. All terms in the plural shall also be taken as singular and vice-versa. Further, any reference to he shall also be applicable to she and vice-versa.

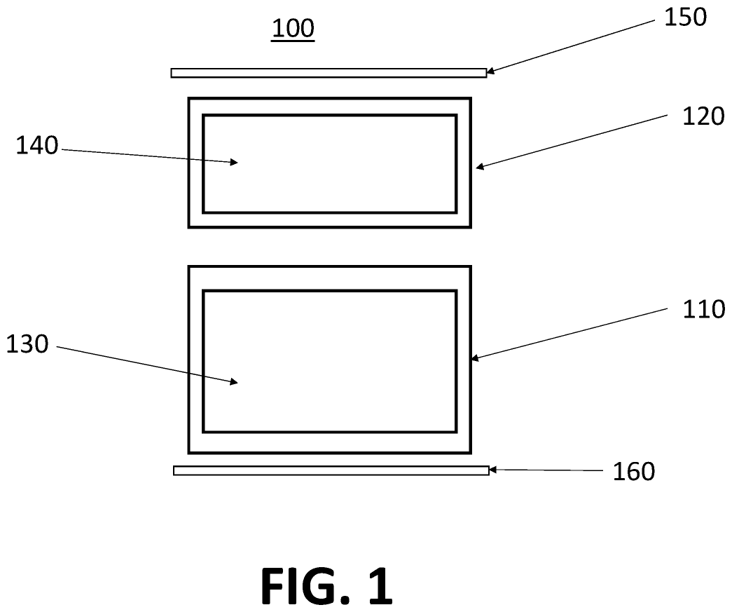

Referring now to FIG. 1, components of a bee hive 100 are described. The bee hive 100 is used to have a colony of bees which will collect pollen from multiple sources such as flowers. The bee hive 100 is generally square in shape, though the bee hive 100 may be round, rectangular, hive shape, etc. The bee hive 100 may be made out of any material including, but not limited to, wood, cardboard, metal, etc. The bee hive 100 may includes a bee hive box, which in turn may includes frames for storing and/or organizing a plurality of honeycomb.

The bee hive 100 has one or more bee hive boxes 110, 120. The one or more bee hive boxes 110, 120 may be any size and may be the same or different in size and shape.

The first of the one or more bee hive boxes 110 has an interior portion 130 which contains honeycomb. The bees bring pollen to the bee hive 100 will deposit their pollen into a honeycomb. The honeycomb is the storage area for converting the pollen to honey.

The second of the one or more bee hive boxes 120 has an interior portion 140 also contains honeycomb. The bees bring pollen to the bee hive 100 will deposit their pollen into a honeycomb. The honeycomb is the storage area for converting the pollen to honey.

The bee hive 100 also has a top 150. The top 150 closes the bee hive 100 and allows only the bees homed in the bee hive 100 entry. The bees homed in the bee hive 100 form a community around a queen bee.

The bee hive 100 also has a bottom 160. The bottom 160 forms the base of the bee hive 100 and is placed on the ground or other firm surface.

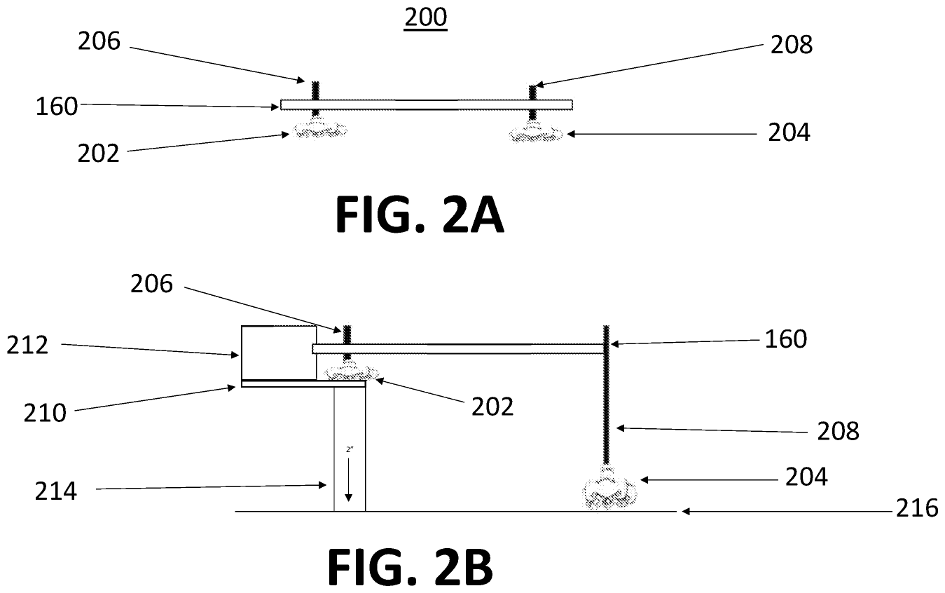

FIG. 2A is an exemplary view of a leveling device 200. The leveling device is useful when the contour of the land does not allow the bee hive 100 to be level.

The leveling device 200 has a first footing 202 and second footing 204. The first footing 202 has a connector 206 which connects to the bottom 160 of the bee hive 100. The second footing 204 has a connector 208 that connects to an opposite side of the bottom 160 of the bee hive. The connector 206 of the first footing 202 may be adjusted by screwing the first footing 202 to the right or to the left depending on whether the first footing 202 is desired to be risen or elongated. The connector 206 of the first footing 202 may be a screw, a latch, a hole-button connector, etc.

Independently, the connector 208 of the second footing 204 may be adjusted by screwing the second footing 204 to the right or to the left depending on whether the second footing 204 is desired to be risen or elongated. The connector 208 of the second footing 204 may be a screw, a latch, a hole-button connector, etc.

FIG. 2B shows the exemplary leveling device 200 being used. A block 212 is shown to abut the bee hive 100 against to keep the bee hive 100 in the desired level.

The contour 210 of the land is uneven such that the first footing 202 is above the second footing 204 and the bottom 160 of the bee hive 100 is tilted. The second footing 204 is adjusted by screwing the connector 208 to the right and elongating the connector to the desired length 214. After the connector 208 of the second footing 204 has been extended to the desired length, the second footing 204 is placed down on the lower surface area 216. The bottom 160 of the bee hive 100 is now level and the pollen and honey will continue to be level in the honeycombs.

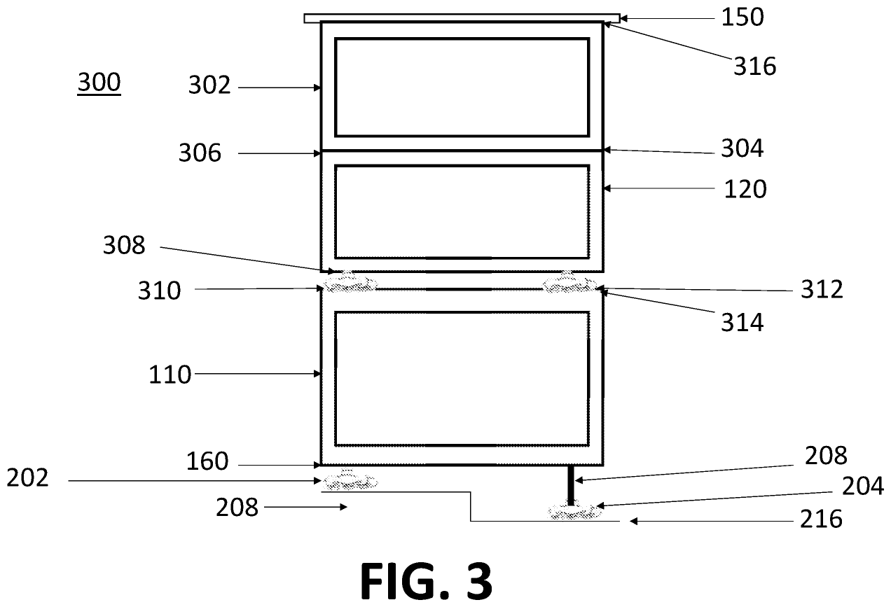

Moving now to FIG. 3, an exemplary bee hive 300 is described. The bee hive 300 has three bee hive boxes, a first bee hive box 110, a second bee hive box 120 and a third bee hive box 302. Although three bee hive boxes are shown in the FIG. 3, the number of bee hive boxes could be one or more depending on the desire and need of the bee keeper.

The first bee hive box 110 has a bottom 160 such that the bee hive 300 has a solid foundation and a top 314. In one embodiment, the top 314 may consist of an open frame, an inner cover, and/or a telescoping cover. The bottom 160 may be configured to support and level a plurality of bee hives, with or without a top 150 on each bee hive box 110. As such, a user may be able to stack multiple bee hive boxes 110 with only a single top 150 being placed on the uppermost bee hive box 110 surface. The bottom 160 of the first bee hive box 110 has a first footing 202 and a second footing 204. The first footing 202 has an adjustable connector, not shown, and the second footing 204 has an adjustable connector 208 to level the bee hive 300 when on an unlevel surface 208.

The first bee hive box 110 is put into a desired location and the second footing 204 is adjusted to allow the bee hive 300 to be level. The connector 208 of the second footing 204 is unscrewed to elongate the connector 208 and the second footing is secured on the surface at the level 216. Thus, the first bee hive box 110 is level.

The second bee hive box 120 has a top 306 and a bottom 308. The bottom 308 of the second bee hive 120 has a first footing 310 and a second footing 312. Each of the first footing 310 and the second footing 312 of the second bee hive 120 have adjustable connectors, not shown. The first footing 310 and the second footing 310 of the second bee hive box 120 is placed on the top 314 of the first bee hive box 110. In this example, the second bee hive box 120 is level, but if the second bee hive box 120 were not level, the first footing 310 and/or the second footing 312 of the second bee hive box 120 would have their connectors, not shown, adjusted to the proper length to level the second bee hive box 120.

The third bee hive box 302 has a top 316 and a bottom 304. The third bee hive box 302 may be equipped with a first and second footing and adjustable connectors but in this example are not so equipped. The bottom 304 of the third bee hive box 302 is placed onto the top 308 of the second bee hive box 120. Since there is not adjustable footings/connector combination equipped on the third bee hive box 302, the third bee hive box 302 is accepted whether level or not. The top 316 of the third bee hive box 302 has the top 150 of the bee hive 300 placed upon it. Thus, the bee hive 300 has now been built to be level and secure.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A bee hive leveler, the bee hive leveler comprising:
a bee hive box, where the bee hive box has an exterior, an interior, a top, and a bottom;
a honeycomb, where the honeycomb is in the interior of the bee hive;
the honeycomb for storing pollen and maturing to honey; and
one or more legs, the one or more legs coupled to the bottom of the bee hive.

2. The bee hive leveler of claim 1, wherein the leg is a foot.

3. The bee hive leveler of claim 2, wherein the foot is adjustable by a screw.

4. The bee hive leveler of claim 1, further comprising a plurality of bee hive boxes.

5. The bee hive leveler of claim 1, wherein each of the plurality of bee hive boxes is stackable.

6. The bee hive leveler of claim 1, wherein the leg is a rod.

7. The bee hive leveler of claim 1, wherein the leg is extendable.

8. The bee hive leveler of claim 1, wherein the leg is extendable and has a hole and a button to secure the leg.

9. The bee hive leveler of claim 1, wherein the leg includes a screw adjusting surface.

10. The bee hive leveler of claim 9, wherein the screw adjusting surface has a locking mechanism.
